(19) United States
(12) Patent Application Publication
(10) Pub. No.: US 2009/0059765 A1
(43) Pub. Date: Mar. 5, 2009

(54) OPTICAL DISK DEVICE AND OPTICAL DISK DISCRIMINATION METHOD

(75) Inventors: Nobuyuki Baba, Kawasaki-shi (JP); Yoshinori Tazaki, Yokohama-shi (JP); Kazumi Sugiyama, Kawasaki-shi (JP); Hiroshi Nakane, Fukaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/201,131

(22) Filed: Aug. 29, 2008

(30) Foreign Application Priority Data
Aug. 30, 2007 (JP) 2007-224367

(51) Int. Cl. G11B 7/135

(52) U.S. Cl. 369/112.01; G9B/7.112

(57) ABSTRACT

According to one embodiment, the invention provides an optical disk device having an irradiation section which applies a laser beam to an optical disk, a detection section which receives a reflected light emitted from the irradiation section and reflected from the optical disk to output a detection signal, and a discrimination section which performs focus search using the irradiation section and the detection section and determines whether the optical disk is a triple layer optical disk on the basis of the detection signal upon performing focus search.

### CROSS-REFERENCE TO RELATED APPLICATIONS

This application is based upon and claims the benefit of priority from Japanese Patent Application No. 2007-224367, filed Aug. 30, 2007, the entire contents of which are incorporated herein by reference.

### BACKGROUND

1. Field

One embodiment of the present invention relates to an optical disk device which detects a triple layer optical disk based on a focus error signal and a focus sum signal upon performing focus search, and an optical disk discrimination method.

2. Description of the Related Art

Recently, optical disks have been widely used in the public, and there are a large variety of optical disks. In an optical disk device, there has been known that the type of optical disk is discriminated by reading management information of the optical disk or by other methods.

Jpn. Pat. Appln. KOKAI Publication No. 2001-307416 discloses a technique for applying a laser beam to an optical disk to discriminate the type of optical disk (CD-ROM, CD-R, or CD-RW) on the basis of the difference in the reflectance of the laser beam.

However, when the above technique is applied to High Definition Digital Versatile Disc (HD DVD), it can be determined that the HD DVD is an optical disk having a low reflectance, but the number of layers included in the HD DVD cannot be determined. Namely, an HD multilayer optical disk cannot be specified only on the basis of the difference in the reflectance of the laser beam.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing a constitution example of an optical disk device according to one embodiment of the invention;

FIG. 2 is a cross-sectional view for explaining a constitution example of a plurality of types of optical disks handled by the optical disk device according to one embodiment of the invention;

FIG. 3 is a graph showing an example of a waveform of a focus error signal or a focus sum signal upon detection of an HD DVD triple layer by the optical disk device according to one embodiment of the invention;

FIG. 4 is a flowchart showing an example of an optical disk discrimination processing in the optical disk device according to one embodiment of the invention; and

FIG. 5 is a flowchart showing an example of an optical disk discrimination processing in the optical disk device according to one embodiment of the invention.

### DETAILED DESCRIPTION

Various embodiments according to the invention will be described hereinafter. In general, according to one embodiment of the invention, there is provided an optical disk device comprising: an irradiation part (15, 16, 17) which applies a laser beam to an optical disk; a detection part (25) which receives a reflected light of the laser beam from the irradiation part to output a detection signal; and a determination part (31) which performs focus search in the irradiation part and the detection part to determine that the optical disk is a triple layer optical disk on the basis of the detection signal.

The number of layers included in an optical disk can be determined by counting the number of times a focus error signal or a focus sum signal, which is changed when a light-focusing part passes through each layer of the optical disk in the focus search, crosses each layer, whereby a processing of reading a system lead-in (SLI) area required for confirming the number of layers is eliminated.

Hereinafter, an embodiment of the invention will be described in detail with reference to the drawings.

<An Example of an Optical Disk Device as One Embodiment of the Invention>

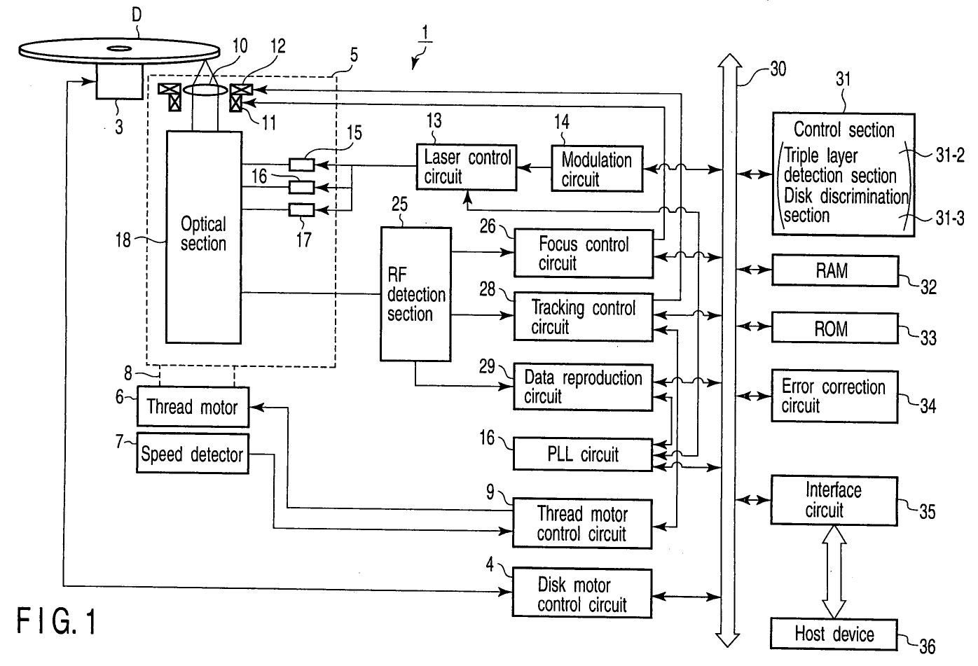

FIG. 1 is a block diagram showing a constitution example of an optical disk device according to one embodiment of the invention. An optical disk D is an optical disk capable of recording user data or a read-only optical disk.

The optical disk D has on its surface land tracks and groove tracks formed in a spiral manner. The optical disk D is placed and fixed onto a disk table (not shown) provided in a rotational shaft of a spindle motor 3, and rotated and driven by the spindle motor 3 under the control of a disk motor control circuit 4.

The recording and reproduction of information with respect to the optical disk D are performed by an optical pick-up 5. The optical pick-up 5 is connected to a thread motor 6 through a gear part 8, and the thread motor 6 is controlled by a thread motor control circuit 9.

A speed detector 7 is connected to the thread motor control circuit 9, and a speed signal from the optical pick-up 5 detected by the speed detector 7 is sent to the thread motor control circuit 9. The thread motor 6 has in its fixed part a permanent magnet (not shown). A drive coil is excited by the thread motor control circuit 9, whereby the optical pick-up 5 is driven in the radial direction of the optical disk D.

The optical pick-up 5 has an objective lens 10 supported by a wire or a plate spring (not shown). The objective lens 10 is driven by a focusing drive coil 11 to move in the focusing direction (in the direction of the optical axis of the lens), and driven by a drive coil 12 to move in the tracking direction (in the direction perpendicular to the optical axis of the lens).

A modulation circuit 14 applies 8-14 modulation (EFM) to a user supplied from a host device 36 through an interface circuit 35 in the recording of information to provide the modulated data. A laser control circuit 13 supplies a write signal and a read signal which is smaller than a semiconductor laser diode signal to semiconductor laser diodes 15, 16, and 17 on the basis of the EFM data supplied from the modulation circuit 14 in the recording of information (in the mark formation). The semiconductor laser diode 15 is a light emitting element of a laser for CD, the semiconductor laser diode 16 is a light emitting element of a red laser for DVD, and the semiconductor laser diode 17 is a light emitting element of a blue laser for HD DVD.

The semiconductor laser diodes 15, 16, and 17 generate a laser beam in response to a signal supplied from the laser control circuit 13. The laser beam emitted from each semiconductor laser diode is applied onto the optical disk D through an optical part 18 and the objective lens 10. The reflected light from the optical disk D is supplied to an RF detection part 25 through the objective lens 10 and the optical part 18. The RF detection part 25 outputs a focus error signal FE in accordance with the difference in an output signal. The output of the focus error signal FE is supplied to a focus control circuit 26. The output signal from the focus control circuit 26 is supplied to the focusing drive coil 11. According to this constitution, the control in which the laser beam is always just focused on a recording film of the optical disk D is performed.

The RF detection part 25 further outputs a tracking error signal TE in accordance with the difference in an output signal. The output of the tracking error signal TE is supplied to the tracking control circuit 28. The tracking control circuit 28 generates a tracking drive signal in response to the tracking error signal.

The tracking drive signal output from the tracking control circuit 28 is supplied to the drive coil 12 for driving the objective lens 10 in the tracking direction. Meanwhile, the tracking error signal used in the tracking control circuit 28 is supplied to the thread motor control circuit 9.

The above focus control and tracking control are performed, whereby the recording information is changed based on an output sum signal RF from the RF detection part 25. The output sum signal is supplied to a data reproduction circuit 29.

The data reproduction circuit 29 reproduces record data on the basis of a clock signal for reproduction from a PLL circuit 19. The data reproduction circuit 29 has a function of measuring the amplitude of the output sum signal RF, and the measured value is read by a control part 31. The control part 31 includes a CPU, a triple layer detection part 31-2, and a disk discrimination part 31-3.

When the objective lens 10 is controlled by the tracking control circuit 28, the thread motor control circuit 9 controls the thread motor 6, that is, the optical pick-up 5 so that the objective lens 10 is positioned near the central position in the optical pick-up 5.

The optical disk motor control circuit 4, the thread motor control circuit 9, the modulation circuit 14, the laser control circuit 13, the PLL circuit 19, the data reproduction circuit 29, the focus control circuit 26, the tracking control circuit 28, and other circuits can be constituted in one LSI chip serving as a servo control circuit, and these circuits are controlled by the control part 31 through a bus 30. The control part 31 controls the overall operation of the optical disk recording/reproduction device in accordance with an operation command supplied from the host device 36 through the interface circuit 35. Further, the control part 31 uses a RAM 32 as a work area, and performs a predetermined control in accordance with a program including the invention recorded in a ROM 33.

<An Optical Disk Discrimination Processing in the Optical Disk Device as One Embodiment of the Invention>

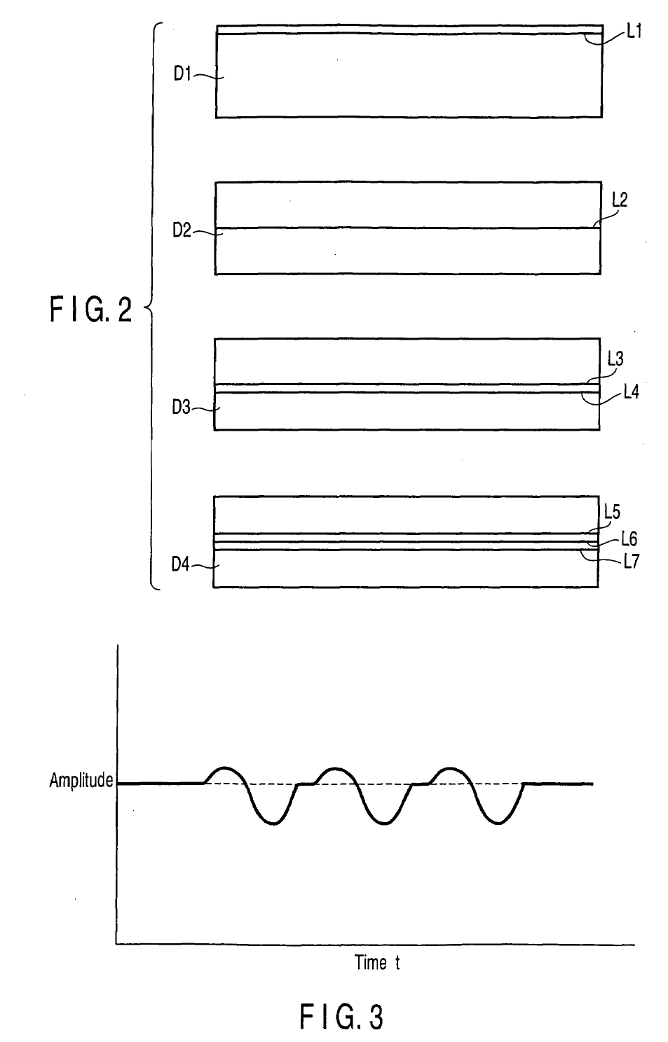

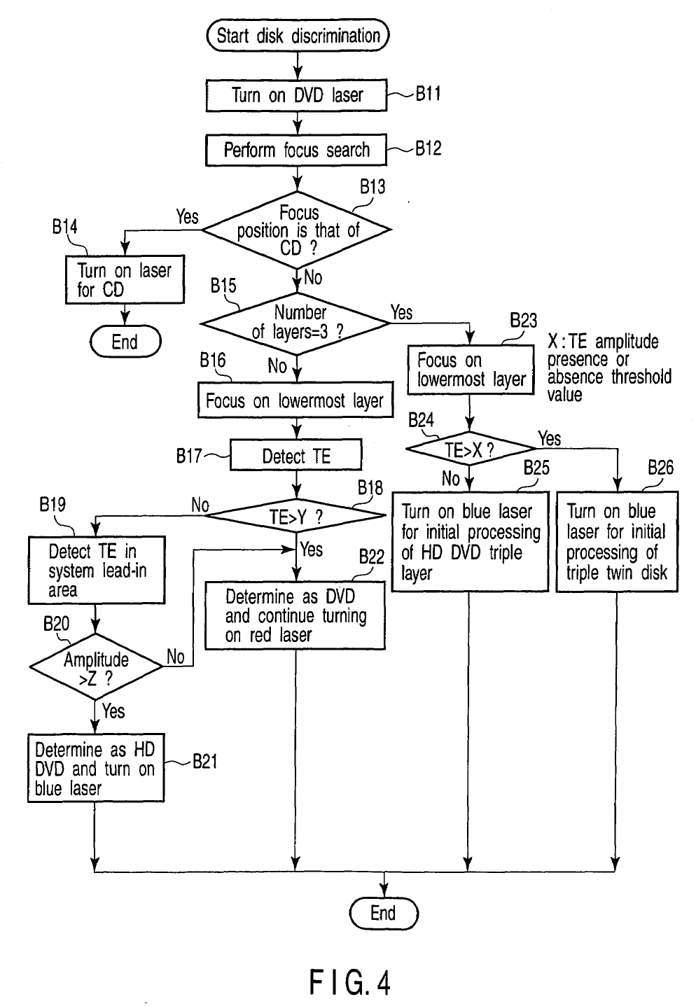

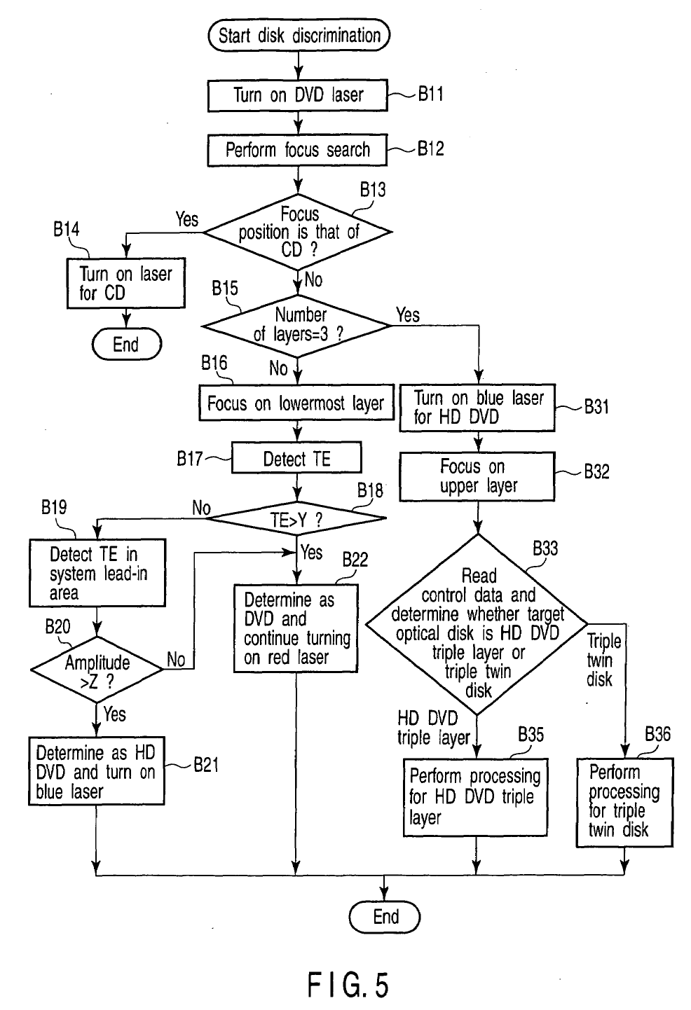

Next, an optical disk discrimination processing in the optical disk device having the above constitution will be described in detail using flowcharts and drawings. FIG. 2 is a cross-sectional view for explaining a constitution example of a plurality of types of optical disks handled by the optical disk device according to one embodiment of the invention. FIG. 3 is a graph showing an example of a waveform of a focus error signal or a focus sum signal upon detection of an “HD DVD triple layer” by the optical disk device according to one embodiment of the invention. FIGS. 4 and 5 are flowcharts showing an example of an optical disk discrimination processing in the optical disk device according to one embodiment of the invention.

Incidentally, each step of the flowcharts of FIGS. 4 and 5 can be replaced with a circuit block, and thus, all steps of each flowchart can be redefined as blocks.

In the optical disk discrimination processing, when the thickness of the optical disk is different from a standard thickness, or when the wavelength of PUH is varied, the thickness and the wavelength are indirectly measured, and focus balance (offset), RF equalizer, tracking balance (offset), and so on which are effective in performance of reproduction and recording are changed in accordance with the thickness of the optical disk, whereby the performance of reproduction and recording is improved.

(The Type of Optical Disk to be Subjected to the Optical Disk Discrimination Processing)

First, the type of optical disk to be subjected to the optical disk discrimination processing will be described using the drawings. The optical disk D to be subjected to the optical disk discrimination processing, as shown in FIG. 2, can be classified into optical disks having four types of cross sections.

Namely, an optical disk D1 is a Compact Disk (CD) having a recording layer L1. An optical disk D2 is a Digital Versatile Disk (DVD) having a single-layer recording layer L2. An optical disk D3 is a double layer DVD having double-layer recording layers L3 and L4 or a double layer HD DVD.

Finally, an optical disk D4 is a triple layer HD DVD having triple layer recording layers L5, L6, and L7 or a triple twin disk (HD DVD double layer+DVD single layer). In the triple twin disk, the lowermost layer is DVD.

(A Method for Detecting “HD DVD Triple Layer” Based on TE After Discrimination of Triple Layer)

Next, an optical disk discrimination processing in the optical disk device according to one embodiment of the invention will be described using the flowchart of FIG. 4. In this embodiment, after the discrimination of triple layer, the HD DVD triple layer is detected based on the tracking error signal TE.

The triple layer detection part 31-2 and the disk discrimination part 31-3 of the control part 31, as shown in FIG. 3, count a characteristic waveform of the focus error signal or the focus sum signal which appears when a light-focusing part (focal point) of a laser beam crosses each layer in the focus search. This waveform is detected three times in a row, whereby it is determined that a target optical disk is a triple layer optical disk.

Hereinafter, a description will be given with reference to the flowchart of FIG. 4. The control part 31 of the optical disk device 1 detects that the optical disk is inserted to start the optical disk discrimination processing. Namely, the control part 31 first turns on the semiconductor laser diode 16 of a red laser for DVD (step B11). The disk discrimination part 31-3 of the control part 31 then performs focus search with respect to the optical disk D with the use of the optical pick-up 5 controlled by the thread motor 6 (step B12). As a result of the focus search, if the focus position of the recording layer L1 is that of CD (step B13), the disk discrimination part 31-3 determines that the optical disk D is CD, and turns on the semiconductor laser diode 15 of a laser for CD (step B14).

Meanwhile, as a result of the focus search, when the control part 31 determines that the focus position of the recording layer L1 is not that of CD, the processing proceeds to step B15. In step B15, the triple layer detection part 31-2 performs focus search, and counts the number of times the light-focusing part crosses each layer on the basis of the focus error signal or the focus sum signal obtained from the RF detection part 25. When the triple layer detection part 31-2 detects that the light-focusing part crosses each layer three times in a row, the triple layer detection part 31-2 determines that the target optical disk is a triple layer optical disk.

If the triple layer detection part 31-2 cannot detect that the light-focusing part crosses each layer three times in a row, the triple layer detection part 31-2 performs focusing on the lowermost layer of the optical disk D (step B16). When the disk discrimination part 31-3 detects the tracking error signal TE (step B17) and the signal exceeds a threshold value Y, the optical disk D is determined as DVD (step B22), and the disk discrimination part 31-3 continues turning on the semiconductor laser diode 16 (red light emitting element) of a laser for DVD.

However, if the tracking error signal TE does not exceed the threshold value Y, the disk discrimination part 31-3 detects the tracking error signal TE in a system lead in area of the optical disk D (step B19). If the tracking error signal TE exceeds a predetermined value Z, the disk discrimination part 31-3 determines the optical disk D as HD DVD, and turns on the semiconductor laser diode 17 of the laser for HD DVD (step B21). In addition, if the tracking error signal TE does not exceed the predetermined value Z, the disk discrimination part 31-3 determines the optical disk D as DVD, and continues turning on the semiconductor laser diode 16 of a laser for DVD (step B22).

Meanwhile, when the control part 31 can detect that the light-focusing part crosses each layer three times in a row in step B15 (step B15, “YES”), the control part 31 performs focusing on the lowermost layer of the optical disk (step B23). If the tracking error signal TE does not exceed a threshold value X, the control part 31 determines the optical disk D as HD DVD triple layer, and turns on the semiconductor laser diode 17 of a laser for HD DVD in order to perform HD DVD initial processing (step B25).

Meanwhile, when the tracking error signal TE exceeds the threshold value X, the control part 31 and the triple layer detection part 31-2 determine the optical disk D as a triple twin disk, and turns on the semiconductor laser diode 17 of a laser for HD DVD in order to perform initial processing of the triple twin disk (step B26).

As described above, in this discrimination method, after lighting of DVD laser, in the focus search, the number of times the light-focusing part crosses each layer is counted based on the focus error signal or the focus sum signal, whereby it is determined whether the target optical disk is a triple layer optical disk. When the optical disk is a triple layer optical disk, the focus servo is turned on in the lowermost layer, and thereafter, it is determined whether the optical disk is a triple twin disk (HD DVD double layer+DVD single layer) or an HD DVD triple layer optical disk based on the size of the tracking error signal. According to this constitution, the conventional process of reading the contents in the SLI (System Lead In) area required for discriminating an optical disk is eliminated, whereby the rapid discrimination processing can be realized.

(A Method for Detecting HD DVD Triple Layer from Control Data After Discrimination of Triple Layer)

Next, an optical disk discrimination processing according a second embodiment of the invention will be described using the flowchart of FIG. 5. In the second embodiment, after discrimination of triple layer, the HD DVD triple layer is detected from control data. The description of the same steps as FIG. 4 is omitted, and therefore only different points will be described.

Namely, in the method shown in the flowchart of FIG. 5, in step B15 where the number of layers is determined whether it is three or not, the control part 31 and the disk discrimination part 31-3 determine that the target optical disk is a triple layer optical disk, and thereafter, turns on the semiconductor laser diode 17 of a laser for HD DVD (step B31). The control part 31 and the disk discrimination part 31-3 then perform focusing on the upper layer of the optical disk D (step B32).

Then, the control part 31 and the disk discrimination part 31-3 read the control data of the optical disk D, and determine that the relevant optical disk is an HD DVD triple layer or a triple twin disk (step B33). When the control part 31 and the disk discrimination part 31-3 determine that the optical disk is an HD DVD triple layer, they perform a processing for an HD DVD triple layer (step B35). Meanwhile, when the control part 31 and the disk discrimination part 31-3 determine that the optical disk is a triple twin disk, they perform a processing for a triple twin disk (step B36).

The example of the second embodiment gives priority to the initialization of the HD DVD layer. First, the optical disk D is determined as a triple layer optical disk by using DVD laser, and thereafter, the DVD laser is switched to the HD DVD laser, the focus servo is turned on the upper layer of the optical disk D, and the control data of the HD DVD layer is read. It is logically determined whether the optical disk D is a triple twin disk (HD DVD double layer+DVD single lager) or an HD DVD triple layer optical disk on the basis of the read control data. According to this constitution, it is possible to eliminate a process in which it is determined whether the optical disk is a triple twin disk or an HD DVD triple layer on the basis of the tracking error signal of the DVD laser in step B24.

According to one embodiment of the invention, the conventional SLI confirmation operation using DVD laser performed with respect to HD DVD becomes unnecessary, whereby the time required for confirming the optical disk can be shortened.

Further, the discrimination whether the lowermost layer of the optical disk is a DVD layer, performed for the purpose of discriminating a triple twin disk, can be omitted, whereby the time required for confirming the HD DVD layer can be shortened.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disk device comprising:
an irradiation part which applies a laser beam to an optical disk;
a detection section which receives a reflected light, reflected from the optical disk, of a laser beam emitted from the irradiation section and focused on an information recording layer of the optical disk, to thereby output a detection signal; and
a discrimination section which performs focus search with respect to the optical disk and determines the optical disk as a triple layer optical disk on the basis of the detection signal obtained as a result of the focus search.

2. The optical disk device according to claim 1, wherein the discrimination section counts the number of times a light-focusing part of the laser beam crosses each layer of the optical disk on the basis of any one of a focus error signal and a focus sum signal detected by the detection section, whereby the discrimination section determines that the optical disk is a triple layer optical disk.

3. The optical disk device according to claim 1, wherein, after the discrimination section determines the optical disk as a triple layer optical disk, the discrimination section performs focusing on the lowermost layer of the optical disk, and determines whether the triple layer optical disk is a triple twin disk or an HD DVD triple layer on the basis of a tracking error signal provided from the detection section.

4. The optical disk device according to claim 1, wherein, after the discrimination section determines the optical disk as a triple layer optical disk, the discrimination section performs focusing on the upper layer of the optical disk, and reads control data of the optical disk, thereby determining whether the triple layer optical disk is a triple twin disk or an HD DVD triple layer.

5. The optical disk device according to claim 1, wherein the discrimination section determines whether the optical disk is CD on the basis of a focus position of the laser beam emitted from the irradiation section in the optical disk.

6. The optical disk device according to claim 1, wherein, after the discrimination section determines that the optical disk is not a triple layer optical disk, the discrimination section determines whether the optical disk is HD DVD or DVD on the basis of the size of the amplitude of a tracking error signal provided from the detection section.

7. An optical disk discrimination method comprising:
applying a laser beam to an optical disk;
performing focus search with respect to the optical disk by using the laser beam;
receiving a reflected light of the laser beam to output a detection signal; and
determining whether the optical disk is a triple layer optical disk on the basis of the detection signal.

8. The optical disk discrimination method according to claim 7, wherein the number of times a light-focusing part of the laser beam. crosses each layer of the optical disk is counted based on any one of a focus error signal and a focus sum signal, whereby it is determined whether the optical disk is a triple layer optical disk.
